(19) United States
(12) Patent Application Publication
(10) Pub. No.: US 2026/0275023 A1
(43) Pub. Date: Sep. 17, 2026

(54) UPCYCLING POLYURETHANE FOAM BY INCORPORATION OF DYNAMIC COVALENT ADAPTABLE NETWORKS

(71) Applicant: Ford Global Technologies, LLC, Dearborn, MI (US)

(72) Inventors: Xiaojiang Wang, Saline, MI (US); Ellen Cheng-chi Lee, Ann Arbor, MI (US); Seyedeh Raziyeh Mohammadi, LaSalle (CA); Thomas Andre, Saline, MI (US)

(73) Assignee: Ford Global Technologies, LLC, Dearborn, MI (US)

(21) Appl. No.: 19/674,995

(22) Filed: May 12, 2026

Related U.S. Application Data
(63) Continuation-in-part of application No. 18/987,726, filed on Dec. 19, 2024.

(51) Int. Cl. C08G 18/32; C08G 18/38

(52) U.S. Cl. CPC C08G 18/3246; C08G 18/3275; C08G 18/3863; C08G 18/3872

(57) ABSTRACT

A thermoplastic polyurethane foam has chemical dynamic covalent adaptable networks. The foam comprises a reaction product of a polyol mixture and an isocyanate mixture. The polyol mixture comprises a polyol and a dynamic cross-linking agent with a content between 0.05 to 70 wt. %. The dynamic cross-linking agent forms dynamic cross-linking bonds.

### CROSS-REFERENCE TO RELATED APPLICATION

This application is a continuation-in-part of and claims the benefit of U.S. application Ser. No. 18/987,726, filed Dec. 19, 2024, and titled “THERMOSET POLYURETHANE FOAM INCORPORATING DYNAMIC COVALENT ADAPTABLE NETWORKS,” the contents of which are incorporated herein by reference in its entirety.

### FIELD

The present disclosure relates to polyurethane foams generally, and more particularly to thermoplastic polyurethane foams.

### BACKGROUND

The statements in this section merely provide background information related to the present disclosure and may not constitute prior art.

Polyurethane (PU) foams are utilized in a variety of automotive applications, as they can form lightweight, flexible, high-resilience, and rigid foams.

Conventional polyurethane foams are manufactured by reacting a polyol mixture with an isocyanate mixture. The polyol mixture reacts with the isocyanate mixture to form a polymer via two reactions. One is the reaction between polyol and isocyanate forming a polyurethane bond; the other is the blowing reaction between water as a blowing agent and isocyanate forming carbon dioxide and a polyurea bond. A polyurethane foam can also be manufactured by the reaction of a polyol and isocyanate with a concurrent blowing process carried out with a physical blowing agent. The formed thermoplastic polyurethane (TPU) foam is reprocessable and can be remolded by compression molding, injection molding, and extrusion; but with limited foam stability.

The present application addresses issues related to thermoplastic polyurethane foams.

### SUMMARY

This section provides a general summary of the disclosure and is not a comprehensive disclosure of its full scope or all of its features.

In one form, the present disclosure provides a thermoplastic polyurethane foam with chemical dynamic covalent adaptable networks. The foam comprises a reaction product of a polyol mixture and an isocyanate mixture. The polyol mixture comprises a polyol and a hindered amine with a content between 0.05 to 70 wt. % of the polyol mixture. The hindered amine forms dynamic cross-linking urea bonds.

In variations of this method, which may be implemented individually or in any combination: between 5% and 100% of the crosslinking sites in the foam are formed by dynamic crosslinking bonds; the hindered amine is an oligomer; the hindered amine is a monomer; the content of hindered amine is between 0.05 and 20.0 wt. % of the polyol mixture; the hindered amine is 4,4′-Trimethylenedipiperidine; and the hindered amine is diethanolamine.

The present disclosure further provides another thermoplastic polyurethane foam with chemical dynamic covalent adaptable networks. The foam comprises a reaction product of a polyol mixture and an isocyanate mixture. The polyol mixture comprises a polyol and a phenol with a content between 0.1 to 70 wt. % of the polyol mixture. The phenol forms dynamic cross-linking bonds.

In variations of this method, which may be implemented individually or in any combination: the polyol mixture further comprises one or more of a cell opener, a surfactant, a blowing agent, and a catalyst; the phenol is an additive; the phenol additive is solid at room temperature; the phenol additive is one or more of lignin, tannin, phenolic resin; the phenol additive content is between 0.1% to 40 wt. % of the polyol mixture; the phenol content is between 0.40 wt. % to 70 wt. % of the polyol mixture; the phenol is 4.4′-sulfonyldiphenol; the phenol content is between 1 and 10 wt. % of the polyol mixture; the phenol is one or more of gallic acid, resveratrol, quercetin, hydroquinone, curcumin, 4,4′-dihydroxybiphenyl, bisphenol, 4,4′-sulfonyldiphenol, 4-aminophenol, 2-hydroxybenzyl alcohol, and 4-hydroxybenzyl alcohol; and between 5% and 100% of the crosslinking sites in the foam are formed by dynamic crosslinking bonds.

The present disclosure further provides another thermoplastic polyurethane foam with chemical dynamic covalent adaptable networks. The foam comprises a reaction product of a polyol mixture and an isocyanate mixture. The polyol mixture comprises a polyol and a disulfide with a content between 0.1 to 70 wt. % of the polyol mixture. The disulfide forms dynamic cross-linking bonds.

In a variation of this method, the disulfide is one or more of 2-hydroxyethyl disulfide, bis(6-hydroxy-2-naphthyl) disulfide, bis(4-hydroxyphenyl) disulfide, 4-aminophenyl disulfide, 2-aminophenyl disulfide.

In another form, the present disclosure provides yet another thermoplastic polyurethane foam with chemical dynamic covalent adaptable networks. The foam comprises a reaction product of a polyol mixture and an isocyanate mixture. The polyol mixture comprises a polyol, a phenol, a hindered amine, and a disulfide. The phenol, the hindered amine, and disulfide form dynamic cross-linking bonds.

In a variation of this method, between 5% and 100% of the crosslinking sites in the foam are formed by dynamic crosslinking bonds.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 shows dynamic bond exchanges for thermoplastic PU foam containing dynamic covalent adaptable networks (CANs).

FIG. 2 shows a chemical structure for several hindered amine compounds according to one aspect of the present disclosure.

FIG. 3A shows a photograph of free-rise foaming result for Example 1 according to one aspect of the present disclosure.

FIG. 3B shows a photograph of free-rise foaming result for Example 2 according to one aspect of the present disclosure.

FIG. 3C shows a photograph of free-rise foaming result for Example 3 according to one aspect of the present disclosure.

FIG. 4A shows a photograph of compressed free-rise foam (under 10 tons at 160° C. for 3 minutes) result for Example 1 according to one aspect of the present disclosure.

FIG. 4B shows a photograph of compressed free-rise foam (under 10 tons at 160° C. for 3 minutes) result for Example 2 according to one aspect of the present disclosure.

FIG. 4C shows a photograph of compressed free-rise foam (under 10 tons at 160° C. for 3 minutes) result for Example 3 according to one aspect of the present disclosure.

FIG. 5 shows a chemical structure for several mono-functional phenol compounds according to one aspect of the present disclosure.

FIG. 6 shows a chemical structure for several di-functional phenol compounds according to one aspect of the present disclosure.

FIG. 7 shows a chemical structure for several tri- and multi-functional phenol compounds according to one aspect of the present disclosure.

FIG. 8 shows a chemical structure for several disulfide compounds according to one aspect of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Covalent adaptable networks (CANs) utilize dynamic chemical covalent bonds that undergo exchange reactions upon application of an external stimulus, typically heat or light. In absence of a stimulus, these materials show high chemical resistance and dimensional stability. When the stimulus is applied, the dynamic bonds become activated, enabling the network to rearrange its topology on a molecular level. As a result, these materials undergo deformations, enabling reshaping and reprocessing. The inventors have discovered that the incorporation of a chemical dynamic CAN into TPU foams enhances foam stability while maintaining reprocessability.

The present disclosure presents a thermoplastic polyurethane foam with a composition in which dynamic cross-linking agents create dynamic cross-linking chemical bonds. Together, the dynamic cross-linking bonds form a chemical dynamic covalent adaptable network in which the crosslink bonds can change and reform. As described herein, the dynamic cross-linking bonds undergo exchange reactions when a stimulus is applied.

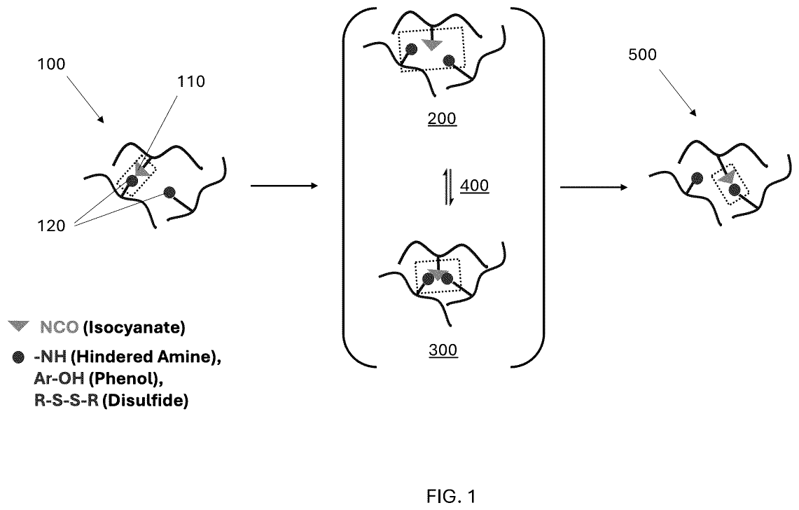

Referring to FIG. 1, the dynamic bond exchanges for dynamic CANs is illustrated. As shown, an initial crosslink 100 is formed by reacting (indicated by dashed lines) isocyanate groups (—NCO) 110 (indicated with triangles) with functional groups 120 such as hindered amines (—NH), phenols (Ar—OH), and disulfides (R—S—S—R) (indicated with circles). When a stimulus 400 is applied, the initial cross-link 100 undergo dynamic bond exchange reactions which switches between an associated intermediate 300 and a dissociated intermediate 200, generating a reformed crosslink 500. Therefore, as used herein, chemical dynamic cross-linking adaptable networks are polymer networks possessing reversible covalent cross-links with the capacity for adapting to an externally applied stimulus. In the present disclosure, the dynamic cross-linking agents in the thermoplastic polyurethane foam present a novel method of producing a chemical dynamic covalent adaptable network.

The thermoplastic polyurethane foam includes the reaction product of an isocyanate with a polyol mixture in which both gelling and blowing reactions occur. The polyol mixture includes at least one polyol and a dynamic cross-linking agent. The dynamic cross-linking agent includes at least one of a hindered amine, a phenol and a disulfide which will each be discussed in more detail below.

In one form, between 5% and 100% of the cross-linking sites in the foam are formed by dynamic cross-linking bonds.

In one form, the cross-linking agent is an additive to the polyol mixture. In another form, the cross-linking agent replaces a portion of the polyol in the polyol mixture. For example, up to 70% of the polyol could be replaced by a hindered amine or a phenol or a disulfide material. Replacement of permanent cross-links in conventional PU foams with dynamic cross-links can increase the processability of foam to film, while maintaining similar free-rise foam foaming ability, and similar heat aging thermal stability. In one form, tri-functional polyol is replaced with a combination of di-functional polyol and one or more of a hindered amine, a phenol, and a disulfide to yield the same cross-link density of dynamic bonds as the previous permanent bonds.

In one form, the polyol mixture also includes additives such as, but not limited to, a cell opener, a surfactant, a catalyst, and/or a blowing agent. Additionally, the polyol mixture in some forms also contains a traditional cross-linking agent such as diethanolamine or triethanolamine. Traditional cross-linking agents are utilized in foam applications to build firmness, increase catalytic activity, strengthen the crosslinked network, and control flexural and other properties of the foam.

As used herein, “isocyanate” as in the isocyanate mixture, includes diisocyanates such as, for example, aromatic diisocyanates, toluene diisocyanates (“TDI”), and methylene diphenyl diisocyanates (“MDI”), as well as polyisocyanates, and mixtures thereof. Non-limiting examples of isocyanates include methylene diphenyl diisocyanate (MDI), toluene diisocyanate (TDI), hexamethylene diisocyanate (HDI), isophorone diisocyanate (IPDI), 4,4′-diisocyanatodicyclohexylmethane (H12MDI), 1,5-naphthalenediisocyanate (NDI), tetramethylxylenediisocyanate (TMXDI), p-phenylenediisocyanate (PPDI), 1,4-cyclohexane diisocyanate (CDI), tolidine diisocyanate (TODI), and combinations thereof. It is contemplated that isocyanates may include polymeric materials.

The polyol includes at least one of petroleum-based polyols, bio-based polyols, and CO2-polyols, as well as mixtures thereof.

As used herein, “petroleum-based polyols” (hereafter “petro-polyol”) are polyether polyols which can be used in the practice of the present disclosure and are well known and widely available commercially. Such polyols are generally at least about 80% by weight or more of a composition or blend of compositions directly or indirectly obtained from a non-renewable resource such as crude oil. Non-limiting examples of the polyether polyols include polyoxyethylene glycol, polyoxypropylene glycol, polyoxybutylene glycol, polytetramethylene glycol, block copolymers, for example, combinations of polyoxypropylene and polyoxyethylene glycols, poly-1,2-oxybutylene and polyoxyethylene glycols, poly-1,4-tetramethylene and polyoxyethylene glycols, and random and block copolymer glycols prepared from blends or sequential addition of two or more alkylene oxides. The mechanical properties of the resultant polyurethane foam may dictate the consistency of the polyol. More specifically, higher molecular weight polyols generally form more flexible polyurethanes, whereas lower molecular weight polyols generally form more rigid polyurethanes.

As used herein, “bio-based polyols” refer to polyols generally at least about 80% by weight or more of a composition or blend of compositions directly or indirectly obtained from a natural (e.g., animal or plant-based) oil. In other embodiments, the polyols are generally at least about 85% by weight, at least 90% by weight, and/or at least 95% by weight or more of a composition or blend of compositions directly or indirectly obtained from a natural oil. Natural oil, as used herein, includes but is not limited to vegetable oils, animal fats, algae oils, tall oils, derivatives of these oils, combinations of any of these oils, and the like. Representative non-limiting examples of vegetable oils include canola oil, rapeseed oil, coconut oil, corn oil, cottonseed oil, olive oil, palm oil, peanut oil, safflower oil, sesame oil, soybean oil, sunflower oil, linseed oil, palm kernel oil, tung oil, jatropha oil, mustard seed oil, pennycress oil, camelina oil, and castor oil. Representative non-limiting examples of animal fats include lard, tallow, poultry fat, yellow grease, and fish oil, as well as polyols made from the bio-based diols 1,3-propanediol (PDO) and 1,4-butanediol (BDO) and diacids, including succinic acid and larger acids such as Elevance's Inherent C18 octadecanedioic acid (ODDA). Representative non-limiting examples of algae oils include microalgae, such as Nannochloropsis, Spirulina, Chlorella; algae, such as red algae-Rhodophyta, red algae, Pithophora oedegonia, green algae, among others, and combinations thereof.

As used herein, carbon dioxide-based polyols are poly(ether carbonate) polyols (hereafter “CO2-polyol”). Non-limiting examples of CO2-polyols include CARDYON® LC-05, available from Covestro Deutschland AG.

Cell openers are used to prepare foam structures that have predominantly open cells, which gives it a larger value of air permeability and include water-soluble emulsifiers.

Surfactants are useful for cell nucleation and cell opening in foam applications and offer foam stabilization. One nonlimiting example of a surfactant is TEGOSTAB® B 4690, available from Evonik Degussa, but it is contemplated other nonionic surfactants may be suitable for preparing the polyurethane foams disclosed herein.

Catalysts enhance the processing characteristics and physical properties of polyurethane foams by promoting the basic chemical reactions between polyol and isocyanate, reactions between water and isocyanate, and reactions to trimerize isocyanates. Catalysts may be selected according to the needs of a particular application, for example, to enhance the polyether foaming process of a wide variety of foams, including high-density unfilled foam, filled foam, high load-bearing flexible foam, low-density foam, and high resilience molded foam. Other catalysts may be selected to delay the foam-forming reaction process, which can result in more open foam structures. Suitable catalysts according to the present disclosure are dibutyltin dilaurate and diluted amine ethers. Tertiary amines may be desirable as catalysts when water is present in the polyol isocyanate reaction mixture, as it catalyzes the isocyanate to react with water to form urea linkages with urethane.

Blowing agents assist in preparing foam, and water is most commonly used as a blowing agent. Other potential blowing agents include fluorocarbons, hydrochlorocarbons, chlorofluorocarbons, hydrofluorocarbons, and/or hydrocarbons. It is also contemplated that gas may be added directly to the polyol isocyanate reaction mixture to form the foam. The particular blowing agent needed is dependent on the foam properties desired for a particular application as well as the selected isocyanate and polyol mixture. The blowing agents disclosed are merely exemplary and other blowing agents or gases may be utilized within the scope of the present disclosure.

Other optional additives include buffers, dendritic macromolecules, inorganic particulates, other types of polyols not listed herein, polyisocyanates, retardants, deodorants, colorants, chain extenders, fillers, combinations thereof, and other additives known to those familiar with the technology as specific application requirements dictate.

As used herein, the “hindered amines” are compounds containing one or more hindered amine functional groups in which the nitrogen atom of an amine group is partially shielded by neighboring groups so that larger molecules cannot easily approach and react with the nitrogen. In the polyurethane foam, the hindered amine functional groups form dynamic cross-linking hindered urea bonds (HUB) at the cross-linking sites. The dynamic cross-linking HUB bonds are a specific type of dynamic cross-linking bond formed by the hindered amine functional groups.

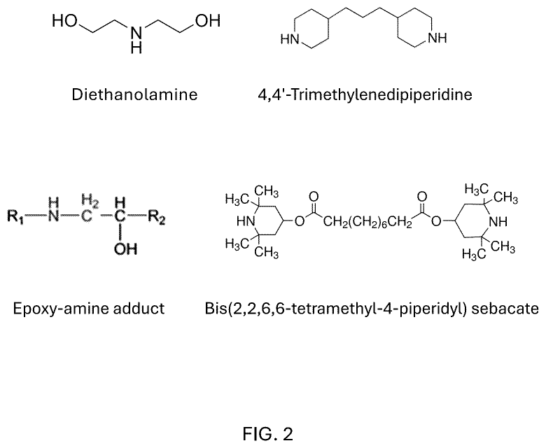

FIG. 2 shows the chemical structure of several hindered amines within the scope of the present disclosure. However, these are merely exemplary, and the possible materials are not limited to those explicitly listed. In one form, the hindered amine includes at least one of 4,4′-trimethylenedipiperidine, diethanolamine, Bis(2,2,6,6-tetramethyl-4-piperidyl) sebacate, epoxy-amine adducts, and oligomeric hindered amine. The hindered amine is either an oligomer or a monomer. In one form, the hindered amine is an oligomer, and its content is between 0.1 and 70 wt. % of the polyol mixture. In one form, the hindered amine is a monomer, and its content is between 0.05 and 20.0 wt. % of the polyol mixture. The neighboring group and molecular weight of the hindered amine affect the hindered amine selection and the hindered amine content of the polyol mixture. The larger the neighboring group, the slower the reactivity of hindered amine towards isocyanates, and the larger content of hindered amine is required to replace polyol. The higher the molecular weight of the hindered amine, the larger content of hindered amine is required to replace polyol.

Table 1 below shows three example compositions used to compare free-rise foam foaming ability, reprocessability, and heat aging stability of polyurethane foams, including (i) Example 1: a control formulation having triol-formed permanent cross-links (ii) Example 2: a diol-only formulation having neither triol-formed PU bonds nor dynamic bonds, and (iii) Example 3: a diethanolamine (DEA) hindered amine formulation according to the present disclosure having dynamic cross-links. Each formulation includes an isocyanate component (Rubinate 7304) (Part A) and a polyol component (Voranol 4701 or Voranol 222-029) along with additives including Lumulse POE 26, Tegostab B 4690, Niax A300 and Niax A1, and water (Part B).

TABLE 1
Examples 1-3: Diethanolamine (DEA) with diols

| | | | | | Example 3 |
|---|---|---|---|---|---|
| | | Eq. Weight | Example 1 | Example 2 | 100_Diol + |
| | Chemicals | (g/mole) | Ctrl_100_Triol | 100 Diol | 3xDEA |
| Part B | Voranol 4701 (Triol) | 1652.40 | 45.60 | | |
| | Voranol 222-029 (Diol) | 1942.00 | | 45.60 | 45.60 |
| | Cardolite ® NX-9006 | 315.00 | | | |
| | Lumulse POE 26 | 1464.75 | 0.46 | 0.46 | 0.46 |
| | Tegostab B 4690 | 1335.70 | 0.23 | 0.23 | 0.23 |
| | Added Water | 9.00 | 1.37 | 1.37 | 1.37 |
| | Diethanolamine LF 85% | 52.57 | 0.69 | 0.69 | 2.14 |
| | Niax A300 | 100.20 | 0.27 | 0.27 | 0.27 |
| | Niax A1 | 233.70 | 0.14 | 0.14 | 0.14 |
| Part A | Rubinate 7304 | 138.66 | 28.88 | 32.07 | 32.07 |

The hindered amine used in the examples is diethanolamine (DEA). Example 1 shows a control formulation in which a triol is used at 100 wt. % of the polyol portion and diethanolamine is used at 1.4 wt. % of part B. Note that this amount of DEA is required in the control formulation as a chain extender for good foam structure. Examples 2 and 3 show formulations using diol at 100 wt. % of the polyol portion to replace the triol and containing DEA hindered amine at 1.4 wt. % (of part B) and 4.4 wt. % (of part B), respectively.

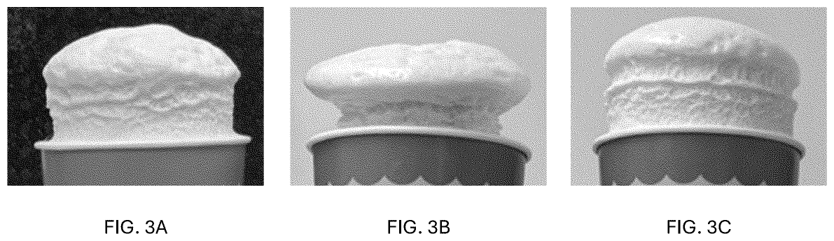

FIGS. 3A-3C show free-rise foaming ability for Examples 1-3 (set forth above in Table 1), respectively. Example 1:100 wt. % polyol is triol, with DEA at 1.4 wt. % of Part B; Example 2:100 wt. % polyol is diol, with DEA at 1.4 wt. % of Part B; Example 3:100 wt. % polyol is diol, with DEA at 4.4 wt. % of Part B). Replacement of the triol with diol without additional DEA hindered amine dynamic cross-linker causes the free-rise foam collapse (FIG. 3B) due to elimination of permanent cross-links from tri-functional polyol (Example 2 vs Example 1); Replacement of the triol with diol with additional DEA hindered amine dynamic cross-linker can hold the foam structure (FIG. 3C) to inhibit foam collapse by adding dynamic cross-links (Example 3 vs Example 1).

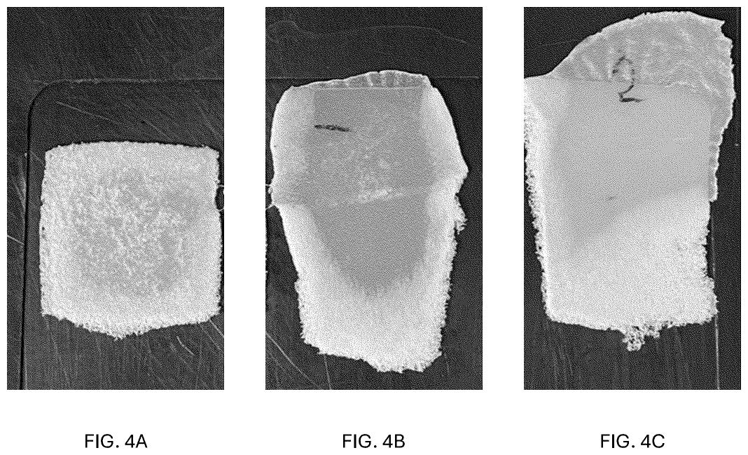

FIGS. 4A-4C shows the free-rise foam compression ability for each of the formulations, Examples 1-3. Examples 2 and 3 show better film forming capabilities during a controlled foam-to-film mold compression process. More specifically, each sample was placed into a press and subjected to a compression process for about 3 minutes under a load of about 10 tons at a temperature of about 160° C. During the compression process, the free-rise foam structures were compressed and reconfigured to form a film-like structure. Example 1, which comprises permanently crosslinks, exhibited limited reprocessability under the compression conditions, resulting in a compressed structure that retained voids (FIG. 4A). In contrast, Examples 2 and 3, which correspond to non-crosslinked and dynamically crosslinked foams, respectively, exhibited enhanced reprocessability under the compression conditions, enabling collapse of the foam cells and formation of a substantially continuous and transparent film (FIG. 4B and FIG. 4C).

As used herein, a “phenol” is a compound that contains a six-membered aromatic ring, bonded directly to a functional hydroxyl group (—OH). The definition includes mono-, di-, tri- or multifunctional phenols and mixtures thereof. In various forms, the phenol, for example, is a mono-phenol such as 4-hydroxybenzyl alcohol (4-HBA), 2-hydroxybenzyl alcohol (2-HBA), or aminophenol; a di-phenol such as bisphenol, 3-methylcatechol, dihydroxybiphenyl, or hydroquinone; or a tri- or multifunctional phenol such gallic acid, quercetin, resveratrol, and lignin.

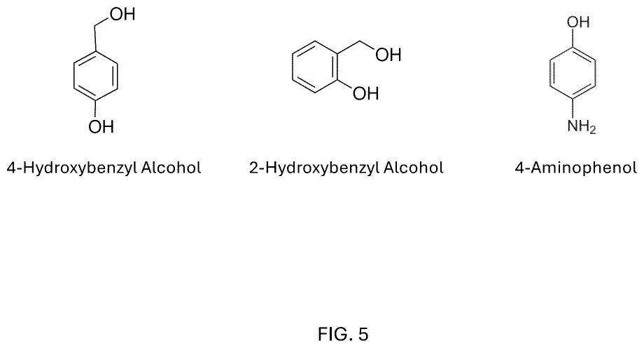

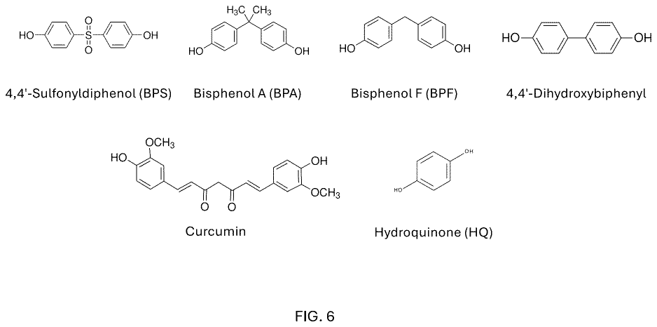

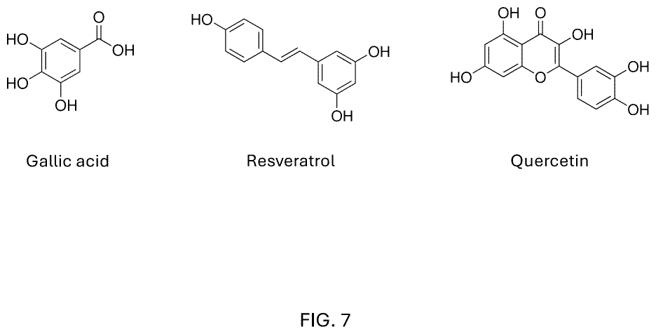

Referring to FIGS. 5-7, the chemical structure of several of phenols set forth above are shown. It should be understood, however, that these phenols are merely exemplary, and the possible phenols are not limited to those explicitly shown. As shown, the phenol may be one or more of 4-aminophenol, 2-hydroxybenzyl alcohol, and 4-hydroxybenzyl alcohol (FIG. 5), hydroquinone, curcumin, 4,4′-dihydroxybiphenyl, bisphenol A, and bisphenol F, 4,4′-sulfonyldiphenol (FIG. 6), or gallic acid, resveratrol, and quercetin (FIG. 7). Reactivity, efficiency, and toxicity of the phenol compound guide its selection. More specifically, the existence of electron withdrawing groups on the phenol aromatic ring favors the phenol reactivity with aromatic isocyanate and provides a more efficient dynamic covalent adaptive network. Low toxicity phenols are favored when phenol is a replacement for the polyol.

In one form, the phenol content is between 0.1 and 70 wt. % of the polyol mixture.

In one form, the phenol is an additive. In one form, the phenol additive forms 0.1-40.0 wt. % of the polyol mixture. In one variation on this form, the phenol additive is solid at room temperature. Compared with liquid phenol, solid phenols have lower reactivity towards isocyanate and less effect on the foam forming property. In one form, the phenol additive is one or more of lignin, tannin, and phenolic resin. Lignin and Tannin are bio phenols and have low toxicity. Phenolic resin is a widely available synthetic resin.

In one form, the phenol is 4.4′-sulfonyldiphenol and the phenol content is between 1 and 10 wt. % of the polyol mixture.

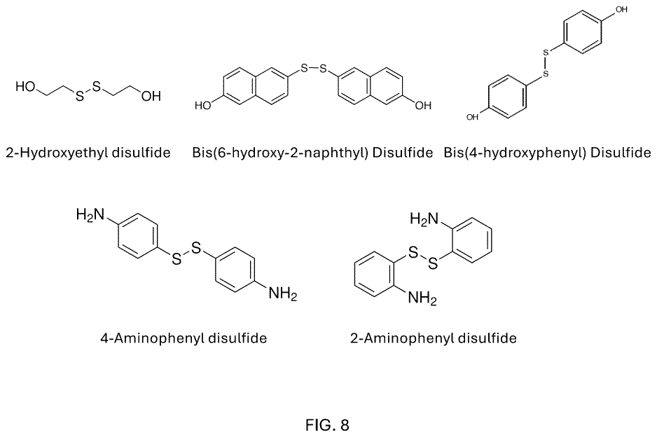

As used herein, a “disulfide” is a compound that contains a sulfur-sulfur (S—S) single covalent bond. The definition includes mono-, di-, tri- or multifunctional disulfide and mixtures thereof. FIG. 8 shows the chemical structure of several of these disulfides; however, these are merely exemplary, and the possible disulfides are not limited to those explicitly listed. In one form, the disulfide is one or more the 2-hydroxyethyl disulfide, bis(6-hydroxy-2-naphthyl) disulfide, bis(4-hydroxyphenyl)disulfide, 4-aminophenyl disulfide, 2-aminophenyl disulfide.

In one form, the disulfide is 2-hydroxyethyl disulfide and disulfide content is between 0.1 and 20 wt. % of the polyol mixture.

In one form, the disulfide is bis(4-hydroxyphenyl)disulfide and disulfide content is between 0.1 and 20 wt. % of the polyol mixture.

In another form of the present disclosure, the polyol mixture may include a phenol, a hindered amine, and a disulfide. In one form, a phenol or a disulfide is utilized to replace a portion of the polyol while a hindered amine is added as an additional cross-linking agent. Alternatively, a smaller amount of each a hindered amine, a phenol, and a disulfide are included as additives. As in other forms described above, the hindered amine, the phenol, and the disulfide form dynamic cross-linking bonds to form a covalent adaptable network. In one form, between 5% and 100% of the cross-linking sites in the foam are formed by dynamic cross-linking bonds.

The foams disclosed herein may be used in various applications where it is desirable to use foams, such as seats in the automotive industry. Other industries include by way of example, the furniture industry and the marine transportation industry. Further, the foams disclosed herein may be used in various automotive applications and for vehicle components, including but not limited to seat backs, arm rests, seat cushions, headliner applications, head rests, engine covers, oil pump covers, air conditioning compressor covers, fuel covers, and under the hood covers, among others. Further, once reprocessed, films and molded components may also be used in any number of applications.

It should also be understood that the composition of the foam includes all incremental values between the minimum content of dynamic cross-linking agent and maximum content of dynamic cross-linking agent values listed above. That is, a minimum content of dynamic cross-linking agent can range from the minimum value to the maximum value described. Likewise, the maximum content of dynamic cross-linking agent can range from the maximum value shown to the minimum value described. For example, the minimum hindered amine content can be 0.05, 0.06, 0.07, 0.08, 0.09, 0.1, 0.2, 0.3, 0.4, 0.5, 0.6, 0.7, 0.8, 0.9, 1.0, 2, 3, 4, 5, 6, 7, 8, 9, 10, 20, 30, 40, 50, 60, or 69.99, and any value between these incremental values.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A thermoplastic polyurethane foam with chemical dynamic covalent adaptable networks, the thermoplastic polyurethane foam comprising:
a reaction product of a polyol mixture and an isocyanate mixture, wherein the polyol mixture comprises a polyol and a hindered amine, the hindered amine having a content between 0.05 to 70 wt. % of the polyol mixture, and the hindered amine forming dynamic cross-linking hindered urea bonds.

2. The thermoplastic polyurethane foam of claim 1, wherein between 5% and 100% of cross-linking sites in the thermoplastic polyurethane foam are formed by dynamic cross-linking hindered urea bonds.

3. The thermoplastic polyurethane foam of claim 1, wherein the hindered amine is an oligomer.

4. The thermoplastic polyurethane foam of claim 1, wherein the hindered amine is a monomer.

5. The thermoplastic polyurethane foam of claim 4, wherein the content of hindered amine is between 0.05 and 20.0 wt. % of the polyol mixture.

6. The thermoplastic polyurethane foam of claim 4, wherein the hindered amine is 4,4′-Trimethylenedipiperidine.

7. The thermoplastic polyurethane foam of claim 4, wherein the hindered amine is diethanolamine.

8. A thermoplastic polyurethane foam with chemical dynamic covalent adaptable networks, the thermoplastic polyurethane foam comprising:
a reaction product of a polyol mixture and an isocyanate mixture, wherein the polyol mixture comprises a polyol and a phenol, the phenol having a content between 0.1 to 70 wt. % of the polyol mixture, and the phenol forming dynamic cross-linking bonds.

9. The thermoplastic polyurethane foam of claim 8, further comprising one or more of a cell opener, a surfactant, a blowing agent, and a catalyst.

10. The thermoplastic polyurethane foam of claim 8, wherein the phenol is one or more of lignin, tannin, phenolic resin.

11. The thermoplastic polyurethane foam of claim 8, wherein the phenol is between 0.1 wt. % and 40 wt. % of the polyol mixture.

12. The thermoplastic polyurethane foam of claim 8, wherein the phenol is between 40 wt. % and 70 wt. % of the polyol mixture.

13. The thermoplastic polyurethane foam of claim 8, wherein the phenol is 4.4′-sulfonyldiphenol.

14. The thermoplastic polyurethane foam of claim 13, wherein the phenol is between 1 and 10 wt. % of the polyol mixture.

15. The thermoplastic polyurethane foam of claim 8, wherein the phenol is one or more of gallic acid, resveratrol, quercetin, hydroquinone, curcumin, 4,4′-dihydroxybiphenyl, bisphenol, 4,4′-sulfonyldiphenol, 4-aminophenol, 2-hydroxybenzyl alcohol, and 4-hydroxybenzyl alcohol.

16. The thermoplastic polyurethane foam of claim 15, wherein between 5% and 100% of cross-linking sites in the thermoplastic polyurethane foam are formed by dynamic cross-linking bonds.

17. A thermoplastic polyurethane foam with chemical dynamic covalent adaptable networks, the thermoplastic polyurethane foam comprising:
a reaction product of a polyol mixture and an isocyanate mixture, wherein the polyol mixture comprises a polyol and a disulfide, the disulfide having a content between 0.1 to 70 wt. % of the polyol mixture, and the disulfide forming dynamic cross-linking bonds.

18. The thermoplastic polyurethane foam of claim 17, wherein the disulfide is one or more of 2-hydroxyethyl disulfide, bis(6-hydroxy-2-naphthyl) disulfide, bis(4-hydroxyphenyl)disulfide, 4-aminophenyl disulfide, 2-aminophenyl disulfide.

19. A thermoplastic polyurethane foam with chemical dynamic covalent adaptable networks, the thermoplastic polyurethane foam comprising:
a reaction product of a polyol mixture and an isocyanate mixture, wherein the polyol mixture comprises a polyol, a phenol, a hindered amine, and a disulfide, wherein the phenol, the hindered amine, and the disulfide form dynamic cross-linking bonds.

20. The thermoplastic polyurethane foam of claim 19, wherein between 5% and 100% of cross-linking sites in the thermoplastic polyurethane foam are formed by the dynamic cross-linking bonds.
